(19) United States
(12) Patent Application Publication
(10) Pub. No.: US 2009/0108216 A1
(43) Pub. Date: Apr. 30, 2009

(54) Relocatable radiation shield for a container scanner

(75) Inventors: Kinya Ichimura, Foster City, CA (US); Philip Tam, Union City, CA (US)

Correspondence Address: GREGORY SMITH & ASSOCIATES, 3900 NEWPARK MALL ROAD, 3RD FLOOR, NEWARK, CA, 94560, US

(73) Assignee: PACECO Corp.

(21) Appl. No.: 11/982,111

(22) Filed: Oct. 31, 2007

(51) Int. Cl. G21F 5/00

(52) U.S. Cl. 250/515.1

(57) ABSTRACT

A shield for radiation used for scanning freight containers is relocatable by cranes and lifts found in freight terminals. The relocatable radiation shield comprises a shield block having at least one solid shielding layer. A layer of the relocatable shield is adapted to hold a shielding fluid for altering a shielding property of the relocatable shield. The fluid-containing layer may optionally be a fluid container attached to or partially embedded within the shield block. The shielding fluid may be removed to reduce the weight of the relocatable radiation shield. In some embodiments the relocatable shield has a channel large enough for passage of a freight container on a conveyance such as a railroad car. An extended shielding structure for shielding a selected path may be assembled from two or more relocatable radiation shields. Some embodiments of a relocatable radiation shield include a freight container.

### FIELD OF THE INVENTION

The present invention relates generally to a shield for high-energy radiation and more specifically to a relocatable radiation shield for radiation used for inspection of freight containers.

### BACKGROUND

Freight containers are used to consolidate cargo items into standardized logistical units for rapid and economical transfer from one form of transport to another. Millions of freight containers are in transit annually, and a large port may process thousands of containers every day. The standardization of containers and container handling and transport equipment has been very successful in improving efficiency and reducing cost, leading to shipment in freight containers of more than ninety per cent of the world's non-bulk cargo.

The contents of freight containers may be inspected for safety, security, or tariff reasons. Generally, only a small fraction of shipments arriving in freight containers at a port or freight terminal are inspected due to logistical limitations. For example, a common type of freight container known as an isotainer has a width dimension of approximately 8 feet (2.4 meters), a height dimension of approximately 8 feet 6 inches (2.6 meters), and one of five standard lengths ranging from approximately 20 feet (6.1 meters) to 53 feet (16.2 meters), although other dimensions are sometimes used. Such a large enclosed volume may hold many thousands of small items, contain some cargo hidden behind or underneath other cargo, or be filled with cargo that is fragile, heavy, toxic, or susceptible to shifting within the container. Unpacking, inspecting, and repacking a container may require the efforts of a dozen or more inspection and freight personnel for ten hours or more. It is well understood within the shipping industry that inspecting the contents of every container by such methods would increase shipping costs and cause unacceptable shipping delays.

Automated scanning systems employing high-energy radiation are sometimes used to inspect sealed freight containers and improve the ability of customs and security agencies to detect hazardous or illegal cargo. Some automated scanners direct X-rays, neutrons, gamma rays, or other forms of radiation from one or more emitters through a freight container to one or more detectors to create an image representing the contents of the container. The image is examined and compared to the freight container's stated manifest. Images of dangerous items, images that are difficult to interpret, or differences between objects visible in an image and the manifest may cause the container to be selected for additional inspection procedures.

Radiation having sufficient energy to penetrate the walls of a freight container and reveal information about the container's contents may be strong enough to be a health hazard to personnel working near an automated scanner. Nearby mechanical, electrical, and electronic systems may also be at risk of malfunction or damage from exposure to radiation from an automated scanner. It is therefore desirable to isolate personnel and equipment from the harmful effects of the radiation.

Several methods of isolating people and equipment from radiation used in automated scanners are known. Some scanners have a metal enclosure surrounding an object to be scanned for absorbing most of the radiation used for scanning. Such scanners, of which an airport luggage scanner is an example, have sufficient shielding to protect personnel and equipment working in close proximity to the scanner. However, the high cost of the scanner's shielding enclosure generally limits such scanners to the examination of relatively small objects. Furthermore, it may be impractical to adapt an existing scanner installation to new types of radiation emitters and detectors or to increase the energy emitted within the scanner to form images of dense targets.

Scanners for large objects such as vehicles or freight containers are sometimes placed inside permanent buildings or between fixed walls to attenuate radiation used in scanning to safe levels. Providing space for fixed structures may be very difficult in crowded terminal areas. Also, the initial cost for a dedicated structure is high, as are the costs for modifying or relocating an existing structure to accommodate changes in preferred logistical flow.

Personnel and equipment may be protected from radiation used in scanning by providing an intervening separation distance between the scanning equipment and personnel work areas. The separation distance comprises a safety zone which personnel are not to enter and in which equipment susceptible to damage or malfunction from radiation is not to be placed during operation of the scanning equipment. The size of the safety zone is proportional to the energy density used for scanning an object. As with permanent shielding structures, finding space for an adequately large safety zone is sometimes impractical, and the size and location of a safety zone may have undesirable effects on logistical flow in a terminal area.

What is needed is a means of shielding radiation from an automatic scanner that is relatively fast and economical to place in operation, safe to use in relatively small areas, relocatable by logistical equipment commonly used in terminal areas and freight yards, adaptable for scanning relatively large or dense objects, adaptable to changes in preferred logistical flow in a terminal area, and adaptable to a variety of automated scanning equipment.

### SUMMARY

The present invention comprises a relocatable radiation shield for radiation used for inspection of freight containers. The relocatable radiation shield comprises at least one layer of solid shielding material. A layer of the relocatable radiation shield is adapted to contain a shielding fluid. For embodiments comprising more than one layer of shielding material, different layers may optionally have different shielding properties. A layer of solid shielding material in combination with a layer adapted to contain a shielding fluid has a combined shielding property effective for selectively shielding X-rays, gamma rays, electromagnetic interference (EMI), radio frequency interference (RFI), high energy neutrons, electrons, protons, alpha particles, beta particles, or other forms of radiation, or combinations of more than one form of radiation. A selected shielding property may correspond to a thickness of a shielding layer, a composition of a shielding layer, a number of shielding layers, a shape of a shielding layer, or a combination of these attributes.

A layer of solid shielding material in combination with a layer adapted to contain a shielding fluid, which may optionally be the same as the layer of solid shielding material or a different layer, may reduce a size and weight of shield needed to achieve a selected shielding property, thereby enabling a radiation shield to be relocatable by logistical equipment commonly found in freight terminals. Some embodiments of the invention may be effective for reducing an amount of radiation escaping from a space containing a source of radiation. Some embodiments of the invention may be effective for preventing an amount of radiation from an external source from entering a space to be shielded.

The solid shielding material portion of the relocatable radiation shield comprises a shield block having at least one layer of material having a selected radiation shielding property, for example a layer of high density concrete optionally mixed with particles of steel, lead, or tungsten individually or in combination. The shield block may optionally comprise one or more additional layers, for example a layer of metal.

The layer adapted to contain a shielding fluid comprises a fluid container for holding a shielding fluid. A shielding fluid is a chemical compound in liquid solution effective for radiation shielding. An inlet fitting and an outlet valve enable shielding fluid to be drained from the fluid container, for example to reduce the weight of the radiation shield prior to relocation, and for the fluid container to be refilled after the radiation shield has been relocated. In some embodiments, the fluid container is formed from metal and is relatively rigid. In other embodiments, the fluid container is formed from a flexible material comprising a polymer compound and a metal having desirable shielding properties such as tungsten or lead. In other embodiments, the fluid container is a void formed in a layer of solid shielding material.

In some embodiments, a relocatable radiation shield has shape that facilitates placing at least two relocatable radiation shields in contact with each other to form an extended shield structure. In one embodiment, the relocatable radiation shield comprises a rectangular shield block and an approximately rectangular fluid container for holding shielding fluid with the fluid container attached on a side to a side of the shield block. In another embodiment, a fluid container is at least partially surrounded by the shield block. These embodiments may be used individually or stacked next to or on top of each other to form an extended radiation shield having a selected height, length, and thickness. Alternatively, a single relocatable radiation shield may have a length, a height, and a thickness to function as an effective radiation shield.

In some embodiments, a relocatable radiation shield is formed with a channel on a bottom side between opposite ends. A size the relocatable radiation shield and a size of the channel are selected to permit a vehicle such as a truck or train carrying a freight container to pass through the channel. Opposite ends of the relocatable radiation shield are shaped to enable assembly of an extended shielding structure comprising at least two radiation shields in close end-to-end contact. Some embodiments have at least one fluid container attached to the outside of the solid shield portion through which the channel is formed.

Some embodiments of a relocatable radiation shield are formed with angled ends. In some embodiments, an angle of a first end and an angle of a second end are the same. In some embodiments, an angle of an end is a right angle. Relocatable radiation shields having angled ends may be used in combination with other shields having angled ends or optionally with parallel ends to form an extended shielding structure for covering a path having a preferred shape.

Another embodiment of a relocatable radiation shield comprises a freight container. The freight container may alternatively be an isotainer with or without doors, a flat rack container, an open top container, a tunnel container, a platform container, or another type of freight container common in the shipping industry.

This section summarizes some features of the present invention. These and other features, aspects, and advantages of the embodiments of the invention will become better understood with regard to the following description and upon reference to the following drawings, wherein:

### BRIEF DESCRIPTION OF THE DRAWINGS

FIG. 1 is a pictorial view of a relocatable radiation shield having a shield block and an external fluid container with optional reinforcing straps.

FIG. 2 is a pictorial view of a relocatable radiation shield having an external fluid container and a shield block comprising more than one layer of shielding material.

FIG. 3 is a pictorial view of a relocatable radiation shield having optional lifting hardware comprising a bar partially embedded within a shield block and also having a fluid container at least partially enclosed in the shield block.

FIG. 4 is a pictorial view of a relocatable radiation shield having a shield block formed with an internal fluid reservoir.

FIG. 5 is pictorial view of a relocatable radiation shield having more than one fluid container at least partially enclosed within a shield block, a channel formed between two ends of the shield block, and an example of optional lifting hardware comprising corner fittings.

FIG. 6 is a pictorial view of a relocatable radiation shield having an enclosed fluid reservoir and a channel formed between two ends.

FIG. 7 is pictorial view of a relocatable radiation shield having more than one external fluid container, sloped sides, and a channel formed between two ends.

FIG. 8 is pictorial view of a plurality of the relocatable radiation shield of FIG. 7 in successive end-to-end contact to form an extended shielded structure.

FIG. 9 is a top view of an embodiment of a shield block having sloped sides, a first end formed with an edge at a first selected angle to a top edge of a side, and a second end formed with an edge at a second selected angle to the top edge of the side.

FIG. 10 is a pictorial view of a plurality of a relocatable radiation shield having a shield block of the embodiment of FIG. 9 and an external fluid container, wherein the relocatable radiation shields are in successive end-to-end contact to form an extended shielding structure for covering a curved path.

FIG. 11 is a top view of a relocatable radiation shield comprising a freight container without doors at an end of the container.

FIG. 12 is a side view of the embodiment of FIG. 11.

FIG. 13 is an end view of the embodiments of FIG. 11 and FIG. 12.

FIG. 14 is an end view of an alternative version of the embodiment of FIG. 11, FIG. 12, and FIG. 13, further comprising doors on the freight container.

FIG. 15 is an end view of an embodiment of a relocatable radiation shield comprising a freight container without doors and further comprising shield block having more than one layer of shielding material.

FIG. 16 is a top view of a relocatable radiation shield comprising a shield block and fluid container attached by support brackets to a flat rack container.

FIG. 17 is a side view of the embodiment of FIG. 16.

### DESCRIPTION

Embodiments of the invention include a relocatable radiation shield comprising a shield block and a fluid container adapted to hold a shielding fluid effective for absorbing radiation, for example liquid containing barium. The fluid container may be at least partially emptied to reduce weight and facilitate moving or maintaining the radiation shield. The relocatable radiation shield has a size and a weight that enables the shield to be moved by cranes or lifts commonly found in freight terminals, thereby enabling the relocatable radiation shield to be installed quickly and moved easily to accommodate desired changes in logistical flow. In some embodiments, the relocatable radiation shield has lifting hardware adapted for use by cranes and lifts such as gantry cranes and top handlers. Such lifting hardware, for example a corner fitting, is well known to manufacturers of freight containers, lifts, and cranes. In some embodiments the relocatable radiation shield has a size that is about the same as a size of a freight container. In other embodiments the relocatable radiation shield is formed with a channel large enough for a freight container on a trailer or train car to pass through the shield. Embodiments of the invention have ends shaped to enable two or more relocatable radiation shields to be placed in close contact to create extended shielding structures of a selected size.

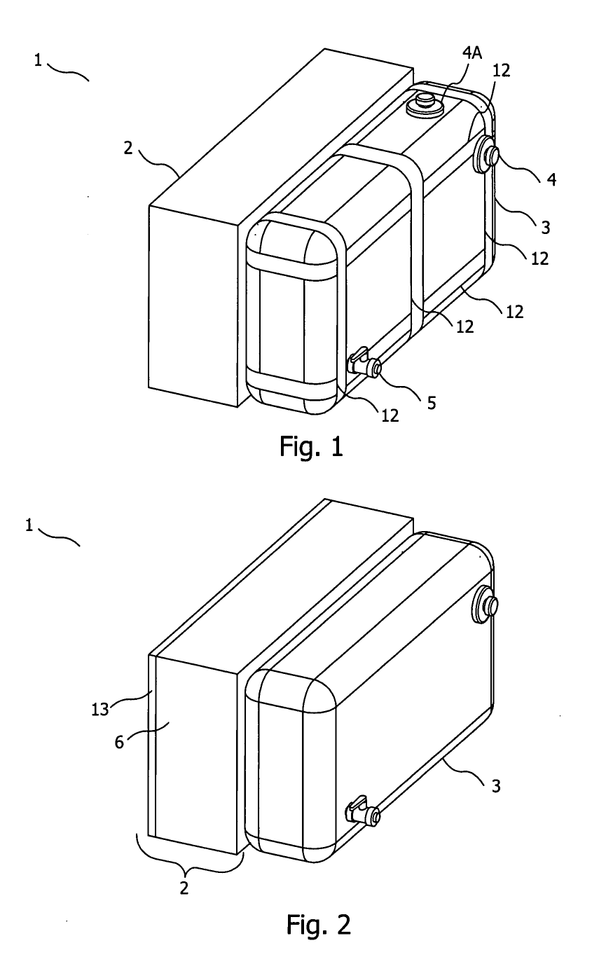

An embodiment of a relocatable radiation shield 1 is shown in FIG. 1. The embodiment of FIG. 1 comprises a shield block 2 formed into a rectangular shape and a fluid container 3 attached on a side to a side of the shield block 2. The shield block 2 may optionally be formed into other shapes, for example, but not limited to, shapes having nonparallel sides, more than six sides, fewer than six sides (as in, for example, a cylinder), or curved sides. The fluid container 3 may be attached to the shield block 2 by bolts, rivets, straps, adhesive, or any other desired attachment means. The fluid container 3 may optionally be detachable from the shield block 2 for maintenance or to reduce the weight of the relocatable shield 1. The fluid container 3 further comprises a fluid inlet fitting 4 for filling and venting the fluid container 3 and an outlet valve 5 for draining the fluid container 3. The fluid inlet fitting 4 has many alternative locations on the fluid container 3. An alternative location of a fluid inlet fitting 4A is shown on a top surface of the fluid container 3 in FIG. 1. In some embodiments, the ends and optionally the sides of the shield block 2 and the fluid container 3 are shaped to facilitate placing relocatable radiation shields 1 one on top of another or end-to-end to form an extended shielding structure.

The shield block 2 has a first selected radiation shielding property and comprises a layer of material having a first selected radiation shielding property, for example a material such as high-density concrete or high-density concrete mixed with particles of one or more metals such as, but not limited to, lead, tungsten, or steel. A sufficient quantity of another material, for example metal particles, may be mixed with the high density concrete to selectively alter a radiation shielding property. A radiation shielding property as used herein refers to a property of a material which causes a change in a measured amount of radiation as the radiation travels from a first location in the material to a second location in the material. In some embodiments, the shield block comprises more than one layer of shielding material wherein each layer has a selected radiation shielding property, a selected mechanical property such as strength, weight, or flexibility, or a combination of selected properties.

The fluid container 3 is formed from a relatively rigid material in some embodiments, for example, an alloy of steel or tungsten. In other embodiments, the fluid container 3 comprises a flexible polymer and a metal such as steel, lead, or tungsten in particulate form mixed with the polymer or in sheet or mesh form laminated in one or more layers to one or more layers of the polymer. The fluid container may optionally include reinforcing elements for maintaining a selected shape of the fluid container. A reinforcing element may include, but is not limited to, a reinforcing strap, a reinforcing patch, a portion of a fluid container wall having increased thickness, or a combination of these elements. An example of a fluid container 3 having a plurality of a reinforcing strap 12 is shown in FIG. 1. A number, size, shape, and position of a reinforcing strap 12 may be selected to maintain the shape of the fluid container 3 within a set of selected dimensional limits.

A relocatable radiation shield having a shield block further comprising a second layer of shielding material is shown in FIG. 2. In FIG. 2, a first layer of shielding material 6 is joined to a second layer of shielding material 13. The two layers of shielding material comprise the shield block 2. Any desired means of attaching the layers of the shield block to each other may be used, for example, but not limited to, bolts, straps, clamps, welding, entrapment by a shape of a layer, or adhesive. In some embodiments, the second layer of shielding material 13 is a layer of metal. The second layer of shielding material 13 may optionally be located on the same side of the shield block 2 as the fluid container 3. The second layer of shielding material 13 is a material having a selected radiation shielding property, for example steel, lead, tungsten, or combinations of these materials. Some embodiments of the shield block 2 comprise more than two layers of shielding material. A number of layers, a thickness of each layer, an order of layers, or a composition of each layer of the shielding block 2 are selected individually or optionally in combination to achieve a selected radiation shielding property.

The shield block 2 of FIG. 1 or FIG. 2 has a length dimension selected from a preferred range of about 1 foot (0.3 meter) to about 40 feet (12 meters), a thickness dimension selected from a preferred range of about 0.5 foot (0.2 meter) to about 4 feet (1.2 meter), and a height dimension selected from a preferred range of about 1 foot (0.3 meter) to about 20 feet (6.1 meters), although a shield block may optionally have other dimensions as desired. The fluid container 3 has dimensions in ranges similar to the corresponding ranges for the shield block 2. In one embodiment, the solid shield block 2 of FIG. 1 or FIG. 2 has a length of about 2 feet (0.6 meter), a height of about 2 feet (0.6 meter) and a thickness of about 1 foot (0.3 meter). In another embodiment, the solid shield block 2 has a height of about 8 feet (2.4 meters), a length of about 20 feet (6.1 meters), and a thickness of about 1 foot (0.3 meter), and the fluid container 3 is about the same size as the solid shield block 2. The metal shield layer 6 shown in FIG. 2 is about 1.0 inch (2.5 centimeters) thick, although any desired value of thickness may optionally be used.

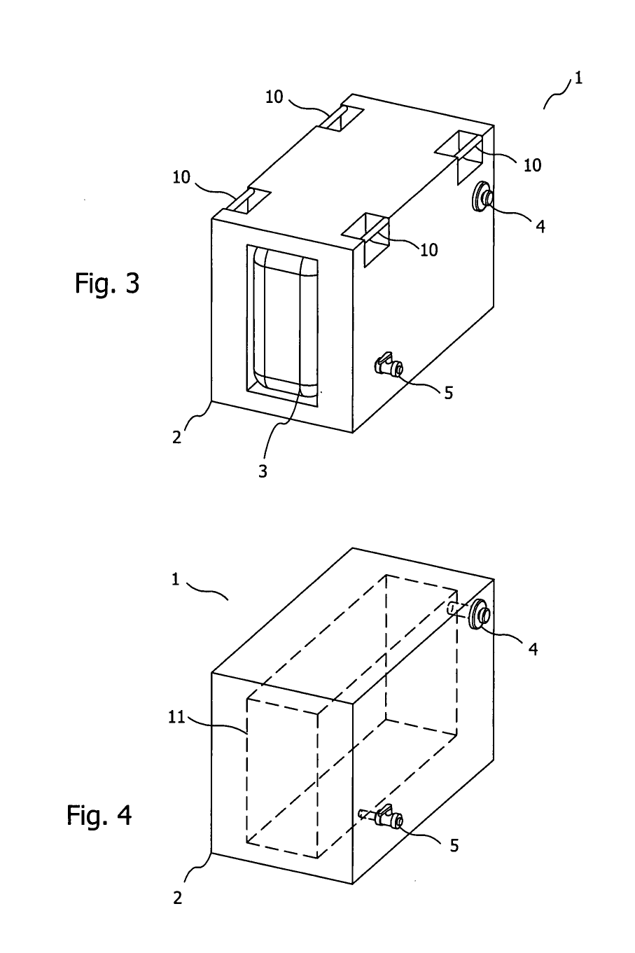

In the embodiments of FIG. 1 and FIG. 2, the fluid container 3 is attached to an outside surface of the shield block 2. A combination of the fluid container 3 and the shield block 2 have a second selected radiation shielding property. The second selected radiation shielding property may be altered by filling the fluid container 3 with a shielding fluid. The fluid container 3 may be attached to the shield block 2 by any desired means, for example, but not limited to, bolts, clamps, straps, or adhesive. The fluid container 3 may optionally be separable from the shield block 2 for repair or replacement or to reduce the weight of the relocatable radiation shield to facilitate relocation of the shield. In the embodiment shown in FIG. 3, a fluid container 3 is at least partially enclosed within the shield block 2. In other embodiments, the fluid container 2 is exposed along a top surface or alternatively a bottom surface of the shield block 2. A fluid inlet fitting 4 and an outlet valve 5 pass through a side of the shield block 2 and make a fluid connection with the fluid container 3.

FIG. 3 further illustrates an example of optional lifting hardware for moving the relocatable radiation shield 1. In FIG. 3, lifting hardware 10 comprises a metal bar embedded in opposite sides of an aperture in the shield block 2. Other examples of lifting hardware 10 include, but are not limited to, a hook, an eyebolt, a ring, and a corner fitting of the type used on a freight container. Lifting hardware 10 is preferably recessed in an aperture as in FIG. 3 to enable placing relocatable radiation shields 1 one on top of another or end-to-end. A number and a location of lifting hardware 10 are selected according to a size, a weight, and a shape of the relocatable radiation shield 1. Any shield block described herein may optionally include lifting hardware 10.

A relocatable radiation shield may optionally be formed with an internal fluid reservoir adapted to hold a shielding fluid. A relocatable radiation shield 1 having an internal fluid reservoir 11 is shown in FIG. 4. A fluid inlet fitting 4 and an outlet valve 5 pass though a side of the shield block 2 to establish fluid connections with the internal fluid reservoir 11. Other locations for the fluid inlet fitting 4 and outlet valve 5 may optionally be used. A size and a shape of the fluid reservoir 11 may optionally be adapted to a size and a shape of the shield block 2.

An extended shielding structure may be assembled from two or more relocatable radiation shields. Relocatable radiation shields may optionally be placed in end-to-end contact, side-to-side contact, or stacked one on another to assemble an extended shielding structure having a selected length, height, thickness, or radiation shielding property. An extended shielding structure may comprise combinations of the relocatable radiation shield embodiments described herein.

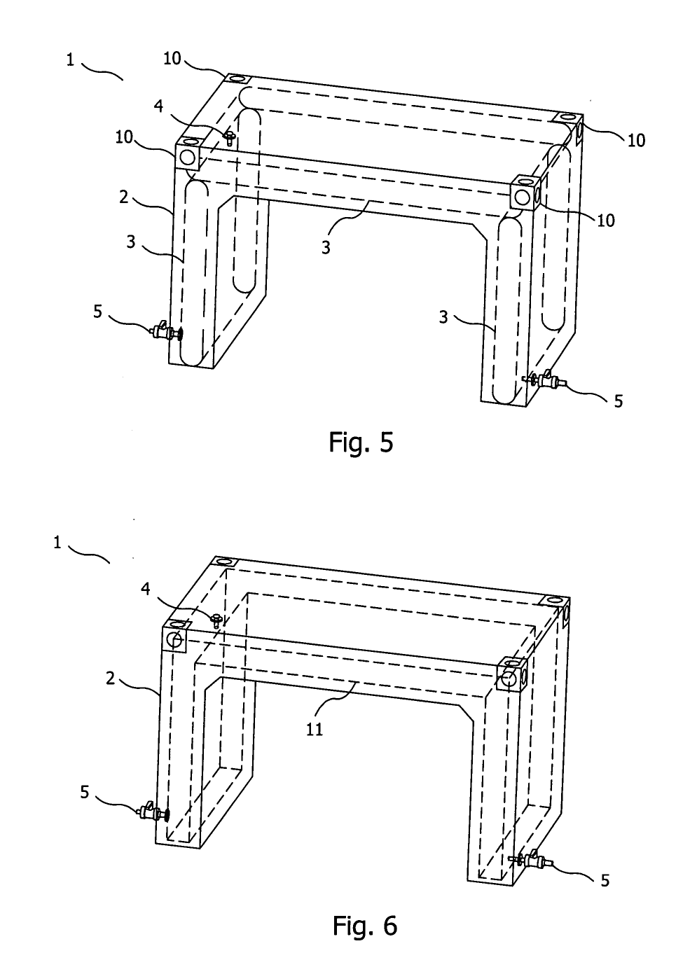

In another embodiment of a relocatable radiation shield, a channel is formed in a bottom side of a shield block to permit an object to be scanned to be pulled through the channel on a conveyance such as a vehicle or a train. The channel also provides space for radiation scanning equipment, for example radiation emitters and radiation detectors. In some embodiments, the channel is large enough to contain scanning equipment on a movable gantry or an equipment cart. In the embodiment of FIG. 5, a channel is formed between a first end and a second end on a bottom side of a shield block 2. A first fluid container 3 is embedded within an upper portion of the shield block 2, a second fluid container 3 is embedded within a first side of the shield block 2, and a third fluid container 3 is embedded within a second side of the shield block 2. A fluid container may optionally be partially exposed to the outside of the shield block 2. The relocatable radiation shield 1 shown in FIG. 5 further comprises optional lifting hardware 10. In the illustrated embodiment, lifting hardware 10 comprises a corner fitting of the type used in freight containers, although other types of lifting hardware may be used as previously described. The lifting hardware 10 may be partially embedded in the shield block 2 as shown or alternately attached to a surface of the shield block 2.

The fluid containers 3 may optionally have connections to permit fluid to flow from one container to another. A fluid inlet fitting 4 on the top of the shield block 2 is connected to the first fluid container 3. A first outlet valve 5 on the first side of the shield block 2 is connected to the second fluid container 3 and a second outlet valve 5 on the second side of the shield block 2 is connected to the third fluid container 3. Alternatively, the three fluid containers 3 may be formed as a single fluid container. In other embodiments, the fluid containers are not connected for fluid flow between them and each fluid container has a separate fluid inlet fitting and outlet valve. In some embodiments, the fluid containers are rigid metal containers and in other embodiments they are flexible polymer containers. A relocatable radiation shield may optionally be formed with an internal fluid reservoir to hold a shielding fluid. An embodiment of a relocatable radiation shield 1 comprising a channel and an internal fluid reservoir 11 is shown in FIG. 6.

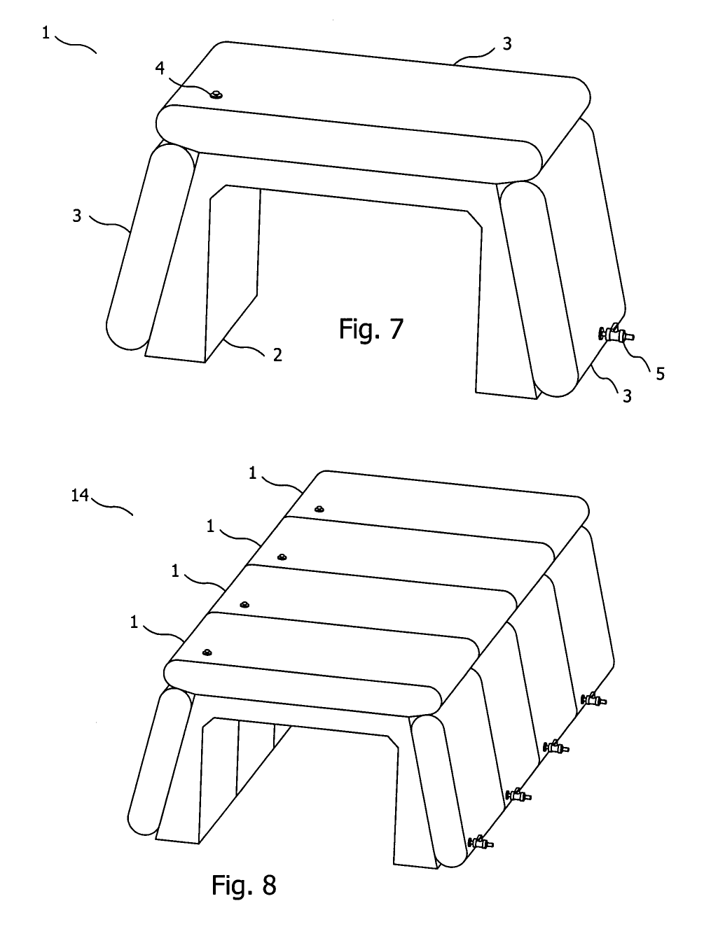

In the embodiment shown in FIG. 7, the fluid containers 3 rest on or alternately are attached to the outside of the shield block 2. The sides of the shield block 2 may be sloped as shown in FIG. 7 to support the flexible fluid containers 3 as illustrated. Alternatively, the sides of the shield block 2 may be vertical. In some embodiments, the fluid containers 3 are rigid metal containers. The fluid containers 3 may have fluid connections between them or may alternatively be separate containers, each with its own inlet fitting and outlet valve. Alternatively, the shield block 2 may be formed with internal fluid reservoirs as previously described. In the embodiment of FIG. 7, a fluid inlet fitting 4 is attached to a first fluid container 3 resting on an upper surface of the shield block 2, a first outlet valve 5 is attached to a second fluid container 3 resting on a first side of the shield block 2, and a second outlet valve 5 (not visible in FIG. 7) is attached to a third fluid container 3 resting on a second side of the shield block 2. In one embodiment, the shield block 2 shown in FIG. 7 is formed with a channel having a length of about 15 feet (4.6 meters), a height of about 14 feet (4.3 meters), and a width of about 18 feet (5.5 meters).

In the embodiments illustrated in FIG. 5, FIG. 6, and FIG. 7, the first and second ends of the shield block 2 are formed with flat faces to facilitate placing relocatable radiation shields 1 in close end-to-end contact to form an extended shielding structure. In other embodiments, end faces may be formed with protrusions and corresponding voids, for example a tongue-and-groove arrangement, to eliminate unobstructed straight-line paths between adjacent relocatable radiation shields in contact with each other along the end faces. End faces with protrusions and corresponding voids may reduce an amount of radiation escaping from between adjacent shields in the extended shielding structure or may improve a mechanical strength or stability of the extended shielding structure. An extended shielding structure 14 comprising four relocatable radiation shields 1 in successive end-to-end contact is illustrated in FIG. 8. A plurality of relocatable radiation shields 1 may be placed in successive end-to-end contact to make a straight extended shielding structure having a selected length. In some embodiments, a fluid container on a relocatable radiation shield 1 has a fluid connection to a fluid container on an adjacent relocatable radiation shield 1.

In some embodiments, the first and second ends of a shield block are not parallel to each other. Instead, an edge of the first end is formed at a first selected angle to an edge of a side of the shield block and an edge of the second end is formed at a second selected angle to the edge of the side. A top view of a shield block 2 having angled ends and sloped sides is illustrated in FIG. 9, wherein A1 represents the first selected angle between a top edge of the first end and a top edge of the side and A2 represents the second selected angle between a top edge of the second end and the top edge of the side.

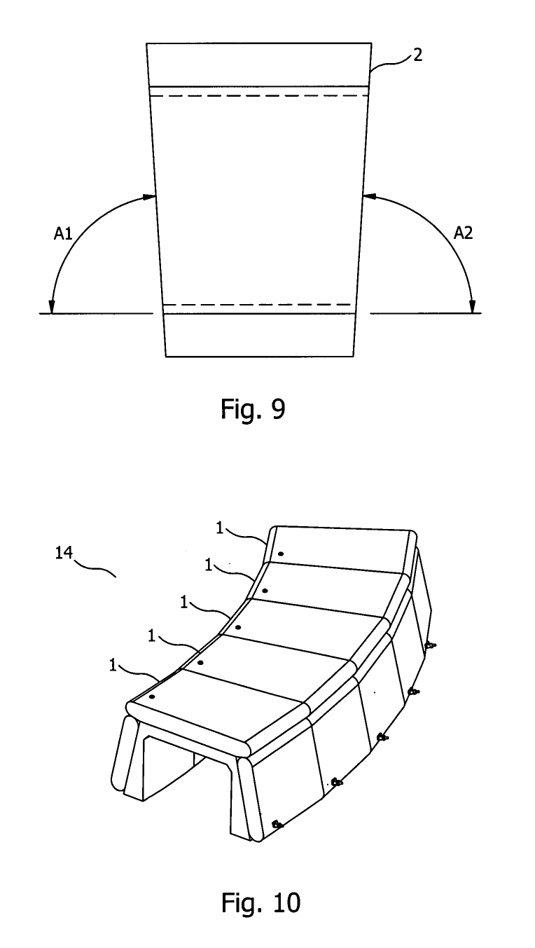

More than one relocatable radiation shield 1 having angled ends may be placed end-to-end to form an extended shielding structure for covering a curved path, as shown in FIG. 10. FIG. 10 shows relocatable radiation shields 1 having external fluid containers. A fluid container on the top of the radiation shield has angled ends matching the angles of the ends of the underlying shield block. Alternately, relocatable radiation shields 1 with angled ends may have internal fluid containers. An extended shielding structure comprising shield blocks with angled ends may be used, for example, to shield a curved portion of a railroad track. The first angle A1 and the second angle A2 may be chosen to create a structure for covering a path having a desired radius of curvature. Alternatively, the first angle Al and the second angle A2 may be different from each other, resulting in an extended shielding structure which does not follow a circular path. Relocatable radiation shields having angled ends, as in FIG. 9, may be used in combination with the embodiments of FIG. 5, FIG. 6, and FIG. 7 to cover a path having some curved portions and some straight portions.

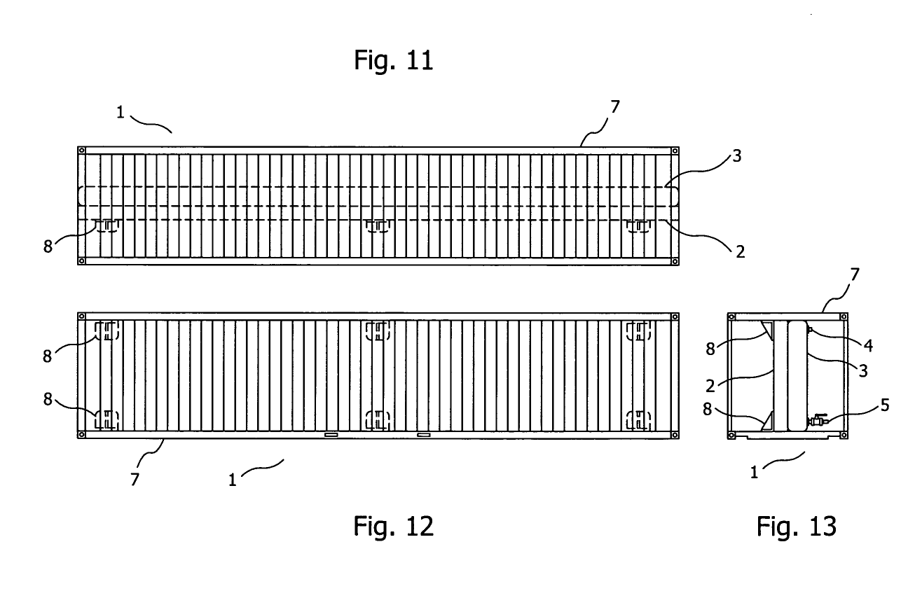

In another embodiment, a relocatable radiation shield comprises a freight container. In some embodiments the freight container is an isotainer. FIG. 11 is a top view of a relocatable radiation shield 1 comprising a freight container 7 having a length of about 40 feet (12 meters). Alternatively, other sizes of freight container may be used. FIG. 12 is a side view of the embodiment of FIG. 11. FIG. 13 is an end view of the embodiment of FIG. 11 and FIG. 12. A shield block 2 having a length dimension about the same as a length dimension of the freight container 7 is located inside the freight container 7. The shield block 2 is attached to the freight container 7 by a plurality of support brackets 8. A fluid container 3 is attached to a side of the shield block 2. A fluid inlet fitting 4 and an outlet valve 5 are attached to the fluid container 3.

In FIG. 11 and FIG. 13, the shield block 2 and fluid container 3 are shown approximately in the center of the freight container 7. In other embodiments the shield block 2 and the fluid container 3 may be located closer to a side of the freight container 7. The fluid inlet fitting 4 and the outlet valve 5 may be located inside the freight container as shown in the figures or may optionally be extended to an outside surface of the freight container 7 to facilitate filling and draining the fluid container 3 from outside the freight container 7.

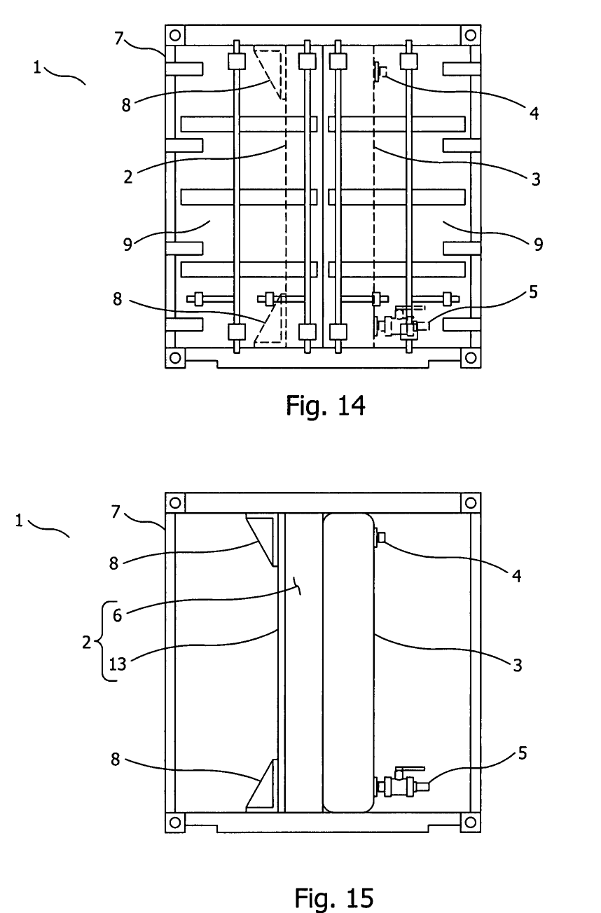

The embodiment of FIG. 13 comprises an isotainer 7 without end doors. The shield block 2 and the fluid container 3 extend to the ends of the freight container 7. Alternatively, the freight container 7 may have doors as shown in the end view of FIG. 14. In the embodiment of FIG. 14, the shield block 2 and the fluid container 3 have a length dimension selected to allow the shield block 2 and fluid container 3 to fit entirely inside the isotainer 7 with the doors 9 closed. Support brackets 8 attach the shield block 2 to a top inside surface and a top bottom surface of the freight container 7. Support brackets 8 may optionally be formed with a different size and shape and may optionally be installed in a different number or location of mounting positions to firmly attach the shield block 2 to the freight container 7. The fluid container 3 is attached to the shield block 2 as previously described.

In the embodiment of FIG. 15, the shield block 2 comprises a first shielding layer 6 and a second shielding layer 13. In this and other embodiments, a shielding property of the relocatable radiation shield may optionally be modified by modifying a thickness of the shield block, by modifying a thickness of the fluid container, or by changing the number, composition, order, or orientation of layers in the shield block 2.

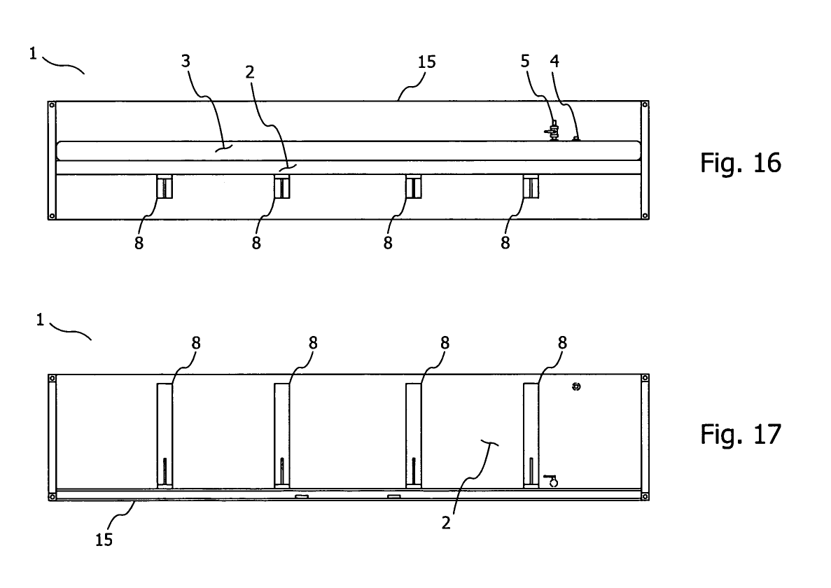

A relocatable radiation shield may optionally comprise a freight container that is unenclosed or partially enclosed. For example, the freight container may be a flat rack container, a platform container, or a tunnel container. An example of a relocatable radiation shield 1 comprising a partially enclosed freight container 15 of a type known as a flat rack container is shown in a top view in FIG. 16 and in a side view in FIG. 17. A plurality of support brackets 8 attaches a shield block 2 to the partially enclosed freight container 15. A size, shape, and number of support brackets 8 are selected to securely attach the shield block 2 to a freight container. The fluid container 3 is attached to the shield block 2 as previously described. The fluid container 3 may optionally be attached to the freight container 15. A fluid inlet fitting 4 may be located near the top of the fluid container 3 to facilitate filling and venting the fluid container. An outlet valve 5 may be located near the bottom of the fluid container 3 to enable removing a shield fluid from the fluid container.

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, or use of equivalent functional steps for steps described herein. Such insubstantial variations are to be considered within the scope of what is contemplated here. Moreover, if plural examples are given for specific means, or steps, and extrapolation between or beyond such given examples is obvious in view of the present disclosure, then the disclosure is to be deemed as effectively disclosing and thus covering at least such extrapolations.

Unless expressly stated otherwise herein, ordinary terms have their corresponding ordinary meanings within the respective contexts of their presentations, and ordinary terms of art have their corresponding regular meanings.

What is claimed is:

1. A relocatable radiation shield comprising:
a shield block having a first selected radiation shielding property;
a fluid container; and
a second selected radiation shielding property,
wherein said shield block and said fluid container cooperate to provide said second selected radiation shielding property.

2. The relocatable radiation shield of claim 1, wherein said shield block comprises a first layer of material having said first selected shielding property.

3. The relocatable radiation shield of claim 2, wherein said first layer of material comprises high density concrete.

4. The relocatable radiation shield of claim 2, wherein said fluid container is formed as a void in said shield block.

5. The relocatable radiation shield of claim 2, wherein said fluid container is at least partially enclosed within said shield block.

6. The relocatable radiation shield of claim 2, further comprising:
a fluid inlet fitting having a fluid connection to said fluid container; and
an outlet valve having a fluid connection to said fluid container.

7. The relocatable radiation shield of claim 2, wherein said shield block further comprises a second layer of material having a third selected shielding property.

8. The relocatable radiation shield of claim 7, wherein said second layer of material is a metal.

9. The relocatable radiation shield of claim 2, further comprising:
a freight container; and
a plurality of support brackets attached to said freight container and to said shield block.

10. The relocatable radiation shield of claim 9, wherein said freight container is an isotainer.

11. The relocatable radiation shield of claim 10, said shield block further comprising a second layer of material having a second selected shielding property.

12. The relocatable radiation shield of claim 2, further comprising at least two of said relocatable radiation shield in close contact.

13. The relocatable radiation shield of claim 2, said shield block further comprising a bottom side, a first end having an edge in common with said bottom side, a second end having an edge in common with said bottom side, and a side having an edge in common with said bottom side, wherein said bottom side is formed with a channel between said first end and said second end.

14. The relocatable radiation shield of claim 13, wherein said channel has a width dimension and a height dimension that are greater than the corresponding dimensions of an isotainer.

15. The relocatable radiation shield of claim 14, further comprising:
a top edge of said first end of said shield block;
a top edge of said second end of said shield block;
a top edge of said side of said shield block;
a first angle between said top edge of said first end of said shield block and said top edge of said side of said shield block; and
a second angle between said top edge of said second end of said shield block and said top edge of said side of said shield block, wherein said first angle has a selected value and said second angle has a selected value.

16. The relocatable radiation shield of claim 15, wherein said fluid container is formed as a void in said shield block.

17. The relocatable radiation shield of claim 15, further comprising a top of said shield block having an edge in common with said first end of said shield block, wherein said fluid container contacts said top of said shield block.

18. The relocatable radiation shield of claim 17, further comprising a second fluid container, wherein said second fluid container contacts said side of said shield block.

19. The relocatable radiation shield of claim 18, said shield block further comprising a second layer of material having a second selected shielding property.

20. The relocatable radiation shield of claim 18, further comprising a plurality of said relocatable radiation shield in successive end-to-end contact.
